(19) United States
(12) Patent Application Publication
(10) Pub. No.: US 2008/0043185 A1
(43) Pub. Date: Feb. 21, 2008

(54) TRANSFLECTIVE DISPLAY UNIT

(75) Inventors: Shie-Chang Jeng, Pingtung County (TW); Hsing-Lung Wang, Taoyuan County (TW); Wei-Ting Hsu, Tainan County (TW); Kang-Hung Liu, Hsinchu County (TW); Chi-Chang Liao, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/554,594

(22) Filed: Oct. 31, 2006

(30) Foreign Application Priority Data
Aug. 21, 2006 (TW) 95130609

(51) Int. Cl. G02F 1/1335

(52) U.S. Cl. 349/114

(57) ABSTRACT

A transflective display unit including a pixel unit, an opposite pixel unit and a liquid crystal layer is provided. The liquid crystal layer is disposed between the pixel unit and the opposite pixel unit. When an electric field is applied between the pixel unit and the opposite pixel unit, the refractive index of the liquid crystal layer is changed and the birefringence of the liquid crystal layer is proportional to a square of the electric field. The pixel unit has a reflective electrode such that a reflective region is defined, and the region not covered by the reflective electrode in the pixel unit is covered by a transparent electrode such that a transmissive region is defined.

### CROSS-REFERENCE TO RELATED APPLICATION

This application claims the priority benefit of Taiwan application serial no. 95130609, filed Aug. 21, 2006. All disclosure of the Taiwan application is incorporated herein by reference.

### BACKGROUND OF THE INVENTION

1. Field of Invention

The present invention relates to a liquid crystal display (LCD). More particularly, the present invention relates to a transflective display unit.

2. Description of Related Art

At present, the multimedia technology is quite advanced, which mainly thanks to the progress in semiconductor devices or display apparatus. As for displays, LCDs with the advantages such as high definition, good space utilization, low power consumption and no radiation have gradually become the mainstream of the market. Generally, LCDs can be classified into three types, namely, transmissive, reflective and transflective LCDs. The transflective LCDs can be used under circumstances of sufficient or insufficient illumination, thus having a wide application scope.

A transflective LCD mainly includes an LCD panel and a back light unit. The LCD panel can be considered as being composed by plenty of display units, i.e., transflective display units. Each transflective display unit has a reflective region and a transmissive region, respectively, which is used for reflecting the external light and permitting the light generated by the back light unit pass through. Generally, in a transflective display unit with a single cell gap, the path of light in the liquid crystal layer at the reflective region is approximately twice of that in the liquid crystal layer at the transmissive region, such that the liquid crystal layers in the reflective region and the transmissive region have different phase retardations. Under the above circumstance, the display quality of the transflective LCD is poor. Take a transflective LCD operated under normally white mode as an example, when no voltage is applied, the transmissive region and the reflective region are both in bright state. At this time, the light should have a phase retardation of λ/2 after passing through the transmissive region, and should have a phase retardation of λ/4 after passing through the reflective region, so as to optimize electro-optic properties. However, in a conventional liquid crystal display with a single cell gap, the transmissive region and reflective region cannot meet the above requirements simultaneously. Besides, an LCD usually has the disadvantages of having small viewing angle, slow response etc., which must be eliminated to enhance the display quality.

### SUMMARY OF THE INVENTION

The present invention is directed to provide a transflective display unit to improve the display quality such as response time and the viewing angle.

As embodied and broadly described herein, the present invention provides a transflective display unit, which comprises a pixel unit, an opposite pixel unit and a liquid crystal layer. The liquid crystal layer is disposed between the pixel unit and the opposite pixel unit. When an electric field is applied between the pixel unit and the opposite pixel unit, the refractive index of the liquid crystal layer is changed and the birefringence of the liquid crystal layer is proportional to a square of the electric field (Kerr effect). The pixel unit has a reflective electrode such that a reflective region is defined, and the region not covered by the reflective electrode in the pixel unit is covered by a transparent electrode such that a transmissive region is defined. As for a transflective LCD operated under normally black mode, when no voltage is applied, the transmissive region and the reflective region are both in a dark state. When a voltage is applied to make the transmissive region and the reflective region in bright state, the light must have a phase retardation of half of wavelength after passing through the transmissive region, and must have a phase retardation of a quarter of wavelength after passing through the reflective region, so as to optimize electro-optic properties. In a preferred embodiment of the present invention, the Kerr constant of the liquid crystal material of the liquid crystal layer is between 10⁻⁸ m/V² and 10⁻⁵ m/V².

In the present invention, the birefringence of the liquid crystal layer is proportional to a square of the electric field, and the Kerr constant of the liquid crystal material of the liquid crystal layer is between, for example, 10⁻⁸ m/V² and 10⁻⁵ m/V². Moreover, due to the Kerr effect of the liquid crystal layer, only a small driving voltage is required for driving the transflective display unit and the transflective display unit may have fast response property.

The present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a sectional view of the transflective display unit according to the present invention.

FIGS. 2-7 are sectional views of a transflective display unit according to the first to sixth embodiments of the present invention.

### DESCRIPTION OF EMBODIMENTS

To improve the electro-optic properties such as viewing angle and response time of the transflective display unit, the present invention improves a transflective display from the aspect of the Kerr effect. The Kerr effect describes that the birefringence of the material induced by the electric field is proportional to a square of the electric field. Specifically, the liquid crystal molecules having Kerr effect satisfy Formula (1):

Δn=KλE² (1)

In Formula (1), Δn is birefringence, K is Kerr constant, λ is the wavelength of the incident light in vacuum, and E is the magnitude of the electric field. Take a transflective LCD operated under normally black mode as an example, the transmissive region and the reflective region are both in a dark state when no voltage is applied. When a voltage is applied to make the transmissive region and the reflective region in bright state, the light should have a phase retardation of half of wavelength after passing through the transmissive region, and should have a phase retardation of a quarter of wavelength after passing through the reflective region, so as to optimize electro-optic properties.

As in general, the liquid crystal molecules have a small Kerr constant, the Kerr effect is not obvious and thus cannot be used practically. Recently, researchers have discovered several methods to increase the Kerr constant, even by more than several orders of magnitude. For example, the Kerr constant can be increased by adopting techniques such as liquid crystal mixtures that can form intermolecular hydrogen bonds, liquid crystal mixtures having smectic phases and particulate liquid crystal mixtures.

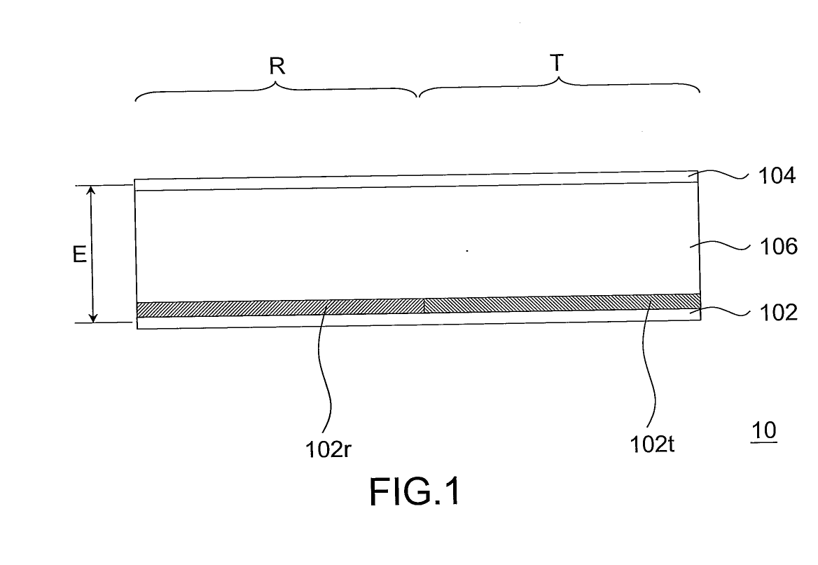

The present invention is described in detail below with reference to FIG. 1, wherein FIG. 1 is a sectional view of the transflective display unit according to the present invention. Referring to FIG. 1, the transflective display unit 10 includes a pixel unit 102, an opposite pixel unit 104 and a liquid crystal layer 106. The transflective display unit 10 of the present invention can be used to fabricate various LCDs. In an active matrix liquid crystal display (AMLCD), the pixel unit 102 includes a glass substrate, a scan line, a data line, an active device and two pixel electrodes disposed on the substrate. Specifically, the pixel unit 102 includes a reflective electrode 102r such that a reflective region R is defined, and the region not covered by the reflective electrode 102r in the pixel unit 102 is covered by a transparent electrode 102t such that a transmissive region T is defined. The opposite pixel unit 104 having an electrode (not shown), and another glass substrate. A color filter can be formed on the glass substrate if it is required. Depending on various types of LCDs, the pixel unit 102 and the opposite pixel unit 104 may have different structures. Therefore, one ordinary skill in the art should understand the structures of the pixel unit 102 and the opposite pixel unit 104 and consider various modifications.

The liquid crystal layer 106 is disposed between the pixel unit 102 and the opposite pixel unit 104, and the Kerr constant of the liquid crystal material of the liquid crystal layer 106 is between, for example, 10⁻⁸ m/V² and 10⁻⁵ m/V². When an electric field E is applied between the pixel unit 102 and the opposite pixel unit 104, the refractive index of the liquid crystal layer 106 is changed and the birefringence of the liquid crystal layer 106 is proportional to a square of the electric field E. In particular, when no electric field is applied to the liquid crystal layer 106, the liquid crystal layer 106 is optical isotropy, and when an electric field is applied to the liquid crystal layer 106, the liquid crystal layer 106 is optical anisotropy.

The transflective display unit of the present embodiment adopts a liquid crystal material with a Kerr constant of 10⁻⁸ m/V²-10⁻⁵ m/V² to constitute the liquid crystal layer 106, such that the liquid crystal layer 106 may have an obvious Kerr effect. Thus, the present invention at least has the following advantages.

(1) The conventional liquid crystal molecules are rotated and oriented under the application of the electric field, thereby changing the birefringence of the liquid crystal layer. However, in the present invention, the distribution of the electron cloud of the liquid crystal molecules in the liquid crystal layer is changed under the application of the electric field, and thus the birefringence of the liquid crystal molecules is changed. Compared with the conventional art, the birefringence of the present invention is changed more rapidly. As the present invention adopts a liquid crystal material with a Kerr constant of 10⁻⁸ m/V²-10⁻⁵ m/V², the impact of the electric field on the liquid crystal molecules is increased and the impact of the elastic energy on the liquid crystal molecules is reduced. As such, the response time of an LCD employing the transflective display unit of the present invention exceeds that of an ordinary LCD.

(2) As the birefringence of the liquid crystal layer is proportional to a square of the electric field, the small change of the electric field could produce great change of the birefringence. In other words, the transflective display unit of the present invention can utilize smaller changes in the electric field to adjust the birefringence of the liquid crystal layer. Therefore, compared with the conventional structure, the transflective display unit of the present invention only requires a smaller driving voltage.

(3) As when no electric field is applied to the liquid crystal layer 106, the liquid crystal layer 106 is optical isotropy, and when an electric field is applied to the liquid crystal layer 106, the liquid crystal layer 106 is optical anisotropy. The transflective liquid crystal display device of the present invention can display an ideal dark state when polarizers are arranged orthogonal to each other, and achieve a high contrast ratio without requiring alignment layers, thereby simplifying the fabricating process of LCDs.

(4) In the transflective display unit of the present invention, the distribution of the electron cloud of the liquid crystal molecules in the liquid crystal layer is changed under the application of the electric field, and thus the birefringence of the liquid crystal molecules is changed, which is different from the convention art wherein the transflective display unit changes the birefringence through the re-orientation of the liquid crystal molecules. Thus, the present invention does not have the viewing angle problem caused by the oriented direction of the liquid crystal molecules as in a conventional LCD. Therefore, the transflective display unit of the present invention is characterized in having a wide viewing angle.

Then, several embodiments are described below to illustrate the spirit of the present invention. However, it should be noted that the following content can only be taken as examples instead of limiting the present invention.

### The First Embodiment

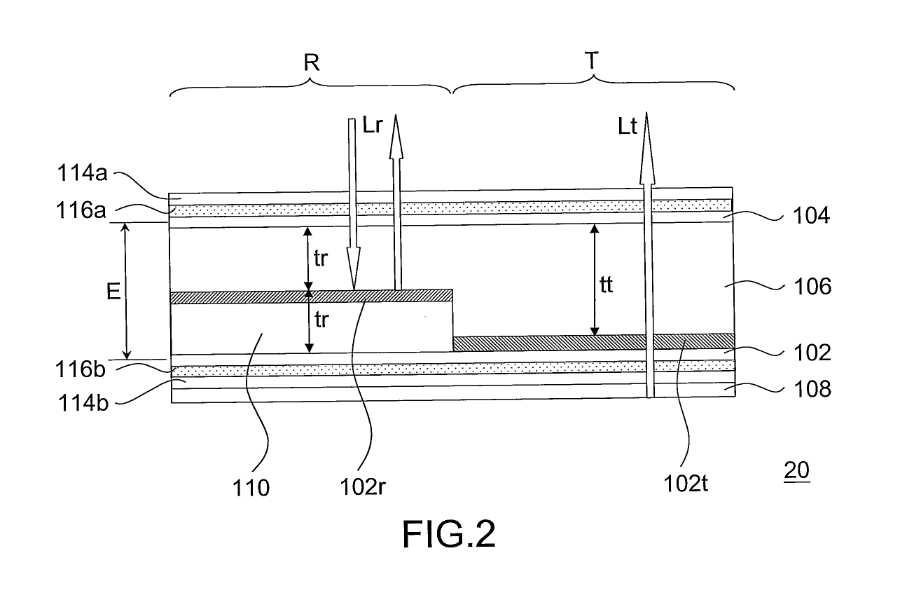

FIG. 2 is a sectional view of a transflective display unit according to a first embodiment of the present invention, wherein the elements illustrated in FIG. 1 are represented by the same symbols and the repetitive content of illustration is omitted.

Referring to FIG. 2, the transflective display unit 20 further includes a back light unit 108. Further, an external light Lr is incident into the reflective region R and then reflected out. A light Lt emitted by the back light unit 108 passes through the transmissive region T to the outside. It should be noted that in this embodiment, the thickness tr of the liquid crystal layer 106 in the reflective region R of the transflective display unit 20 is less than the thickness tt of the liquid crystal layer 106 in the transmissive region T. During the incident and emitting processes, the traveling path of the light Lr in the liquid crystal layer 106 of the reflective region R is the thickness tr, and the traveling path of the light Lt emitted from the back light unit 108 in the liquid crystal layer 106 of the transmissive region T is the thickness tt. Therefore, the total traveling paths of the lights Lr and Lt in the liquid crystal layer 106 are the same. The phase retardation caused by liquid crystal material satisfies Formula (2):

r=dΔn (2)

with r representing the phase retardation, d representing the light traveling path and Δn representing the birefringence. In addition, the light Lr has the same wavelength as the light Lt. Accordingly, when an electric field is applied to display bright state, the light may have a phase retardation of half of wavelength after passing through the transmissive region, and have a phase retardation of a quarter of wavelength after passing through the reflective region, so as to optimize electro-optic properties.

The transflective display unit 20 further includes a passivation layer 110 disposed in the reflective region R and between the pixel unit 102 and the liquid crystal layer 106. The total thickness of the passivation layer 110 and the reflective electrode 102r is tr, which is identical to the thickness tr of the liquid crystal layer 106 of the reflective region R.

In this embodiment, the transflective display unit 20 further includes a first polarizer 114a, a second polarizer 114b, a first phase retardation film 116a and a second phase retardation film 116b. The first phase retardation film 116a is disposed outside the opposite pixel unit 104, and the second phase retardation film 116b is disposed outside the pixel unit 102. The first polarizer 114a is disposed outside the first phase retardation film 116a, and the second polarizer 114b is disposed outside the second phase retardation film 116b. Moreover, the first phase retardation film 116a and the second phase retardation film 116b, for example, may cause the same phase retardation. The light Lr is incident from the outside, and sequentially passes through the first polarizer 114a, the first phase retardation film 116a, the opposite pixel unit 104 and the liquid crystal layer 106 of the reflective region R to reach the reflective electrode 102r. After that, the light Lr is reflected by the reflective electrode 102r, and sequentially passes through the liquid crystal layer 106 of the reflective region R, the opposite pixel unit 104, the first phase retardation film 116a and the first polarizer 114a to the outside. Meanwhile, the light Lt is emitted from the back light unit 108, and sequentially passes through the second polarizer 114b, the second phase retardation film 116b, the pixel unit 102, the transparent electrode 102t, the liquid crystal layer 106 of the transmissive region T, the opposite pixel unit 104, the first phase retardation film 116a and the first polarizer 114a to the outside.

In another embodiment, the wavelengths of the lights Lr, Lt are λ, for example, and the phase retardation of the first phase retardation film 116a and that of the second phase retardation film 116b are, for example, λ/4.

### The Second Embodiment

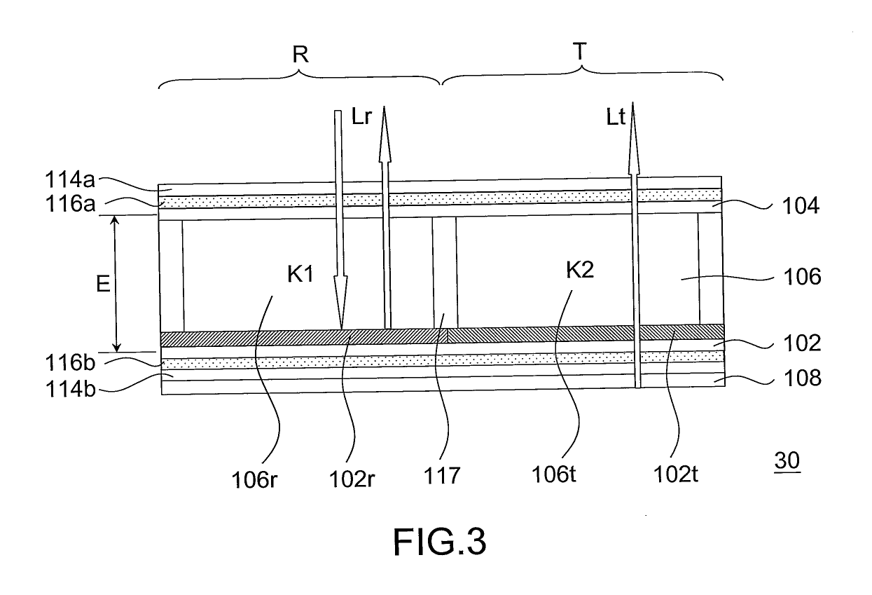

FIG. 3 is a sectional view of a transflective display unit according to a second embodiment of the present invention, wherein the elements illustrated in FIG. 2 are represented by the same symbols and the repetitive content of illustration is omitted.

Referring to FIG. 3, the transflective display unit 30 further includes a plurality of isolating walls 117 disposed between the pixel unit 102 and the opposite pixel unit 104. The liquid crystal layer 106 includes a first liquid crystal layer 106r disposed in the reflective region R and a second liquid crystal layer 106t disposed in the transmissive region T, wherein the first liquid crystal layer 106r and the second liquid crystal layer 106t are isolated by the isolating walls 117. In addition, the birefringence of the first liquid crystal layer 106r is half of that of the second liquid crystal layer 106t. To achieve the above structure, liquid crystal materials having different Kerr constants are used to form the first liquid crystal layer 106r and the second liquid crystal layer 106t. The Kerr constant K1 of the first liquid crystal layer 106r is half of the Kerr constant K2 of the second liquid crystal layer 106t. As such, when an electric field is applied to display bright state, the light has a phase retardation of half of wavelength after passing through the second liquid crystal layer 106t of the transmissive region T and the light may have a phase retardation of a quarter of wavelength after passing through the first liquid crystal layer 106r of the reflective region R, so as to optimize electro-optic properties. In particular, the wavelength of the light is λ, for example, and the phase retardation of the first liquid crystal layer 106r is, for example, λ/4. In addition, the phase retardations of the first phase retardation film 116a and the second phase retardation film 116b can be λ/4. Moreover, the light Lr is incident from the outside, and sequentially passes through the first polarizer 114a, the first phase retardation film 116a, the opposite pixel unit 104 and the first liquid crystal layer 106r to reach the reflective electrode 102r. After that, the light Lr is reflected by the reflective electrode 102r, and sequentially passes through the first liquid crystal layer 106r, the opposite pixel unit 104, the first phase retardation film 116a and the first polarizer 114a to the outside. Meanwhile, the light Lt is emitted from the back light unit 108, and sequentially passes through the second polarizer 114b, the second phase retardation film 116b, the pixel unit 102, the transparent electrode 102t, the second liquid crystal layer 106t, the opposite pixel unit 104, the first phase retardation film 116a and the first polarizer 114a to the outside.

### The Third Embodiment

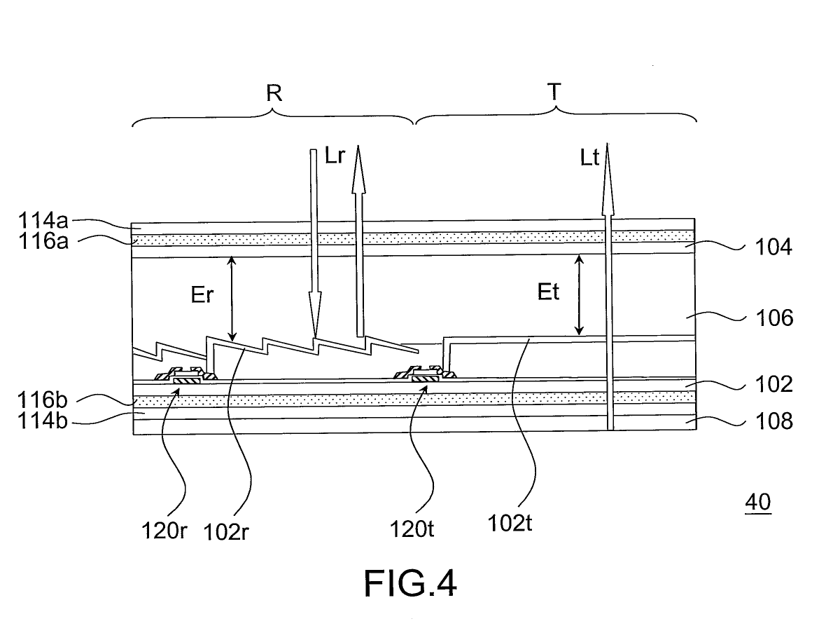

FIG. 4 is a sectional view of a transflective display unit according to a third. embodiment of the present invention, wherein the elements illustrated in FIG. 2 are represented by the same symbols and the repetitive content of illustration is omitted.

Referring to FIG. 4, the pixel unit of the transflective display unit 40 includes a first active device 120r and a second active device 120t. The first active device 120r is electrically connected to the reflective electrode 102r to drive the liquid crystal molecules in the reflective region R, and the second active device 120t is electrically connected to the transparent electrode 102t to drive the liquid crystal molecules in the transmissive region T. Moreover, the first active device 120r and the second active device 120t apply the voltage level of the reflective electrode 102r and the transparent electrode 102t different. An electric field Er is generated between the reflective electrode 102r and the opposite pixel unit 104, and an electric field Et is generated between the transparent electrode 102t and the opposite pixel unit 104. As such, according to Formula (1), the liquid crystal layer 106 may have different birefringence in the reflective region R and the transmissive region T by individually adjusting the electric fields Er and Et. Therefore, when an electric field is applied to display bright state, the light may have a phase retardation of half of wavelength after passing through the liquid crystal layer 106 of the transmissive region T, and have a phase retardation of a quarter of wavelength after passing through the liquid crystal layer 106 of the reflective region R, so as to optimize electro-optic properties.

Moreover, the first phase retardation film 116a and the second phase retardation film 116b, for example, may cause the same phase retardation. For example, the wavelengths of the lights Lr, Lt are, for example, λ, and the phase retardation of the first phase retardation film 116a and that of the second phase retardation film 116b are, for example, λ/4. The light Lr is incident from the outside, and sequentially passes through the first polarizer 114a, the first phase retardation film 116a, the opposite pixel unit 104 and the liquid crystal layer 106 of the reflective region R to reach the reflective electrode 102r. After that, the light Lr is reflected by the reflective electrode 102r, and sequentially passes through the liquid crystal layer 106 of the reflective region R, the opposite pixel unit 104, the first phase retardation film 116a and the first polarizer 114a to the outside. Meanwhile, the light Lt is emitted from the back light unit 108, and sequentially passes through the second polarizer 114b, the second phase retardation film 116b, the transparent electrode 102t, the liquid crystal layer 106 of the transmissive region T, the opposite pixel unit 104, the first phase retardation film 116a and the first polarizer 114a to the outside.

### The Fourth Embodiment

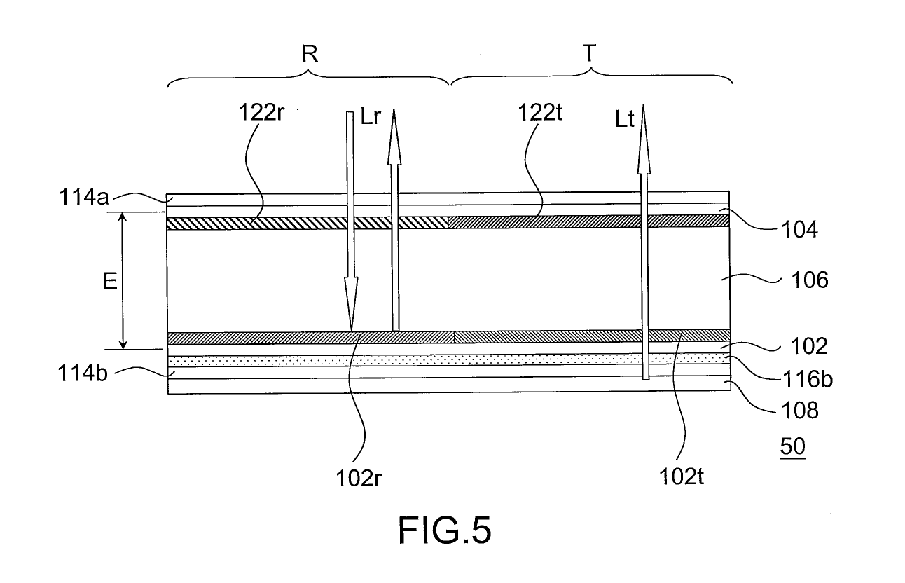

FIG. 5 is a sectional view of a transflective display unit according to a fourth embodiment of the present invention, wherein the elements illustrated in FIG. 2 are represented by the same symbols and the repetitive content of illustration is omitted.

Referring to FIG. 5, the transflective display unit 50 further includes a third phase retardation film 122r and a fourth phase retardation film 122t. The third phase retardation film 122r is disposed between the opposite pixel unit 104 and the liquid crystal layer 106 in the reflective region R. The fourth phase retardation film 122t is disposed between the opposite pixel unit 104 and the liquid crystal layer 106 in the transmissive region T. The third phase retardation film 122r and the fourth phase retardation film 122t have different phase retardations. In this embodiment, the phase retardation of the third phase retardation film 122r is a quarter of that of the fourth phase retardation film 122t. For example, the phase retardation caused by the third phase retardation film 122r is λ/4, and the phase retardation caused by the fourth phase retardation film 122t is λ or the fourth phase retardation film 122t causes no phase retardation. The light Lr is incident from the outside, and sequentially passes through the first polarizer 114a, the opposite pixel unit 104, the third phase retardation film 122r and the liquid crystal layer 106 of the reflective region R to reach the reflective electrode 102r. After that, the light Lr is reflected by the reflective electrode 102r, and again sequentially passes through the liquid crystal layer 106 of the reflective region R, the third phase retardation film 122r, the opposite pixel unit 104 and the first polarizer 114a to the outside. Meanwhile, the light Lt is emitted from the back light unit 108, and sequentially passes through the second polarizer 114b, the second phase retardation film 116b, the pixel unit 102, the transparent electrode 102t, the liquid crystal layer 106 of the transmissive region T, the fourth phase retardation film 122t, the opposite pixel unit 104 and the first polarizer 114a to the outside. The phase retardation of the second phase retardation film 116b is, for example, λ/4, and when an electric field is applied to display bright state, the phase retardation of the liquid crystal layer 106 is, for example, λ/2. According to the phase retardation relation provided by the above films, the phase retardation caused by the third phase retardation film 122r and the phase retardation caused by the fourth phase retardation film 122t can be adjusted individually by the designer to optimize electro-optic properties.

Furthermore, in the transflective display unit 50 of the present invention, the relation between the third phase retardation film 122r and the fourth phase retardation film 122t is not limited. In other words, in another embodiment, the phase retardation caused by the third phase retardation film 122r may not be a quarter of the phase retardation caused by the fourth phase retardation film 122t but varies according to the operating mode of the liquid crystal layer 106.

### The Fifth Embodiment

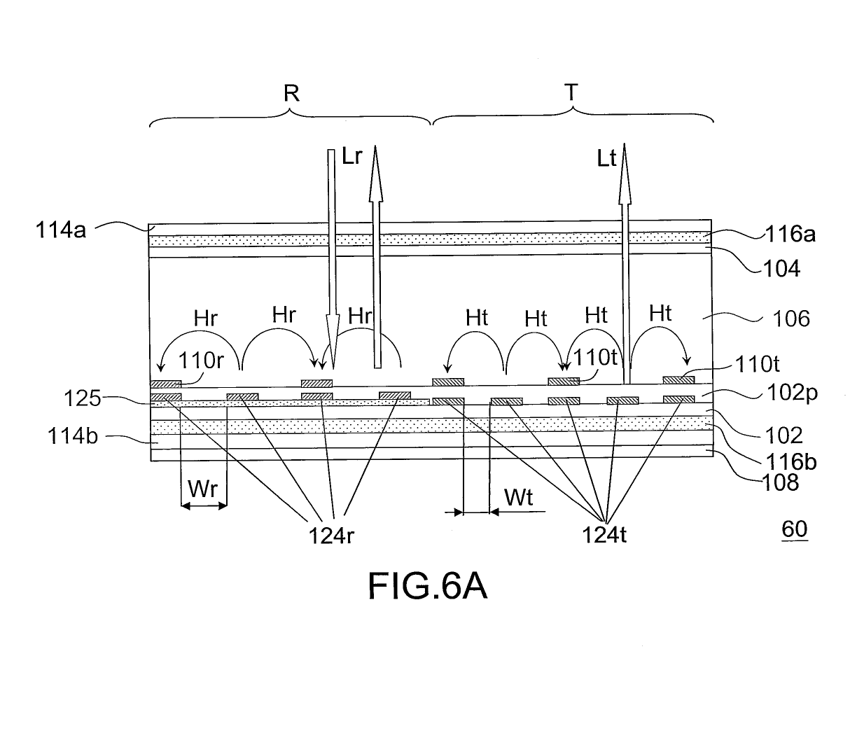

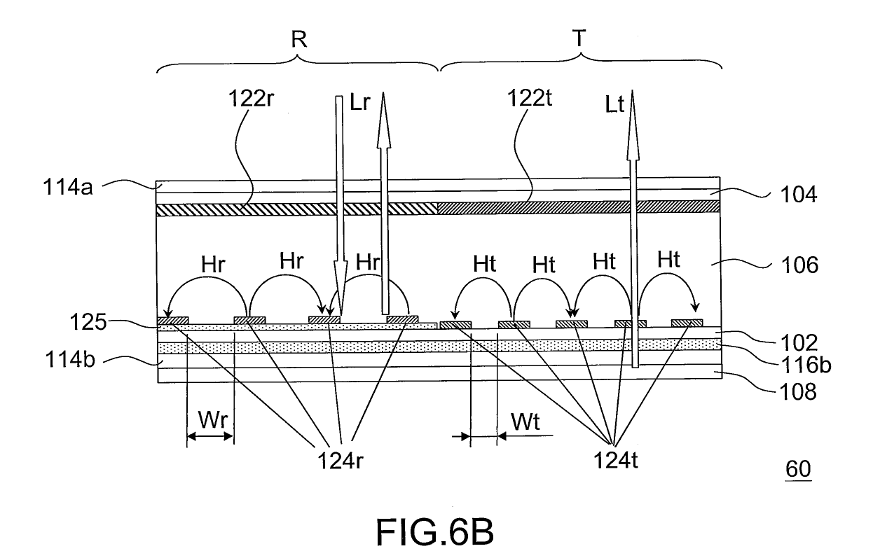

In another embodiment, the structure similar to that of the transflective display unit 50. can be operated like an in-plane switching (IPS) transflective display unit, as shown in FIGS. 6A and 6B. FIGS. 6A and 6B are sectional views of a transflective display unit according to a fifth embodiment of the present invention, wherein the elements illustrated in FIG. 2 are represented by the same symbols and the repetitive content of illustration is omitted.

Referring to FIG. 6A, the transflective display unit 60 of the present invention includes a plurality of first electrodes 124r and a plurality of second electrodes 124t. Generally, a transflective display unit 60 is provided with a reflective electrode 102r with a function of reflection and a transparent electrode 102t. However, in the fifth embodiment, the transflective display unit 60 has a plurality of reflective layers 125 and a plurality of IPS transparent electrodes 110t but has no reflective electrode 102r and transparent electrode 102t. Particularly, in the fifth embodiment, the reflective layers 125 are disposed on the reflective region R of the pixel unit 102 for replacing the reflection function of reflective electrode 102r. The reflective layers 125 are made of dielectric material, for example, TiO₂. However, the reflective layer 125 can be made of conducting material, for example aluminum. Under such circumstance, a dielectric layer must be disposed between the reflective layer 125 and the first electrode 124r to prevent the electrical conduction between them. In this embodiment, the first electrodes 124r and the second electrodes 124t are common electrodes. In other words, the first electrodes 124r have the same electrical potential, so do the second electrodes 124t.

Moreover, the pixel unit 102 is provided with a passivation layer 102p disposed between the first electrodes 124r and the IPS reflective electrode 110r, and between the second electrodes 124t and the IPS transparent electrode 110t, so as to electrically isolate the electrodes. The first electrodes 124r are disposed on the reflective region R of the pixel unit 102. By aligning the IPS reflective electrode 110r and first electrodes 124r properly, a plurality of transverse electric fields Hr is generated between the IPS reflective electrode 110r and the first electrodes 124r and acts on the liquid crystal layer 106 of the reflective region R. In addition, the second electrodes 124t are disposed on the transmissive region T of the pixel unit 102. By aligning the IPS transparent electrode 110t, and the second electrodes 124t properly, a plurality of transverse electric fields Ht is generated between the IPS transparent electrode 110t, and the second electrodes 124t and acts on the liquid crystal layer 106 of the transmissive region T. The aligned IPS reflective electrode 110r and first electrode 124r are served as two electrodes of a storage capacitor, and the aligned IPS transparent electrode 110t, and second electrode 124t are also served as two electrodes of a storage capacitor.

Moreover, the gap Wt between the second electrodes 124t is less than the gap Wr between the first electrodes 124r. Therefore, the transverse electric field Ht is greater than the transverse electric field Hr. As such, according to Formula (1), the liquid crystal layer 106 may have different electric field magnitudes in the reflective region R and the transmissive region T by individually designing the gap between the first electrodes 124r and the second electrodes 124t, thus generating different birefringence. For example, when an electric field is applied to display bright state, the light may have a phase retardation of half of wavelength after passing through the second liquid crystal layer 106t of the transmissive region T, and have a phase retardation of a quarter of wavelength after passing through the first liquid crystal layer 106r of the reflective region R, so as to optimize electro-optic properties.

Referring to FIG. 6B, in an alternative embodiment, the transflective display unit 60 of the present invention may include a plurality of first electrodes 124r and a plurality of second electrodes 124t. Similar to the above description of FIG. 6A, a transflective display unit 60 is provided with a reflective electrode 102r with a function of reflection and a transparent electrode 102t. However, in this embodiment, the transflective display unit 60 has a plurality of reflective layers 125 but has no reflective electrode 102r and transparent electrode 102t. Particularly, in this embodiment, the reflective layers 125 are disposed on the reflective region R of the pixel unit 102 for replacing the reflection function of reflective electrode 102r. The reflective layers 125 are made of dielectric material, for example, TiO₂. However, the reflective layer 125 can be made of conducting material, for example aluminum. Under such circumstance, a dielectric layer must be disposed between the reflective layer 125 and the first electrode 124r to prevent the electrical conduction between them.

The first electrodes 124r are disposed on the reflective region R of the pixel unit 102. Through an appropriate electrical potential arrangement, a transverse electric field Hr is generated between two adjacent first electrodes 124r and acts on the liquid crystal layer 106 of the reflective region R. The second electrodes 124t are disposed on the transmissive region of the pixel unit 102. Through an appropriate electrical potential arrangement, a transverse electric field Ht is generated between two adjacent second electrodes 124t and acts on the liquid crystal layer 106 of the transmissive region T. Moreover, the gap Wt between the second electrodes 124t is less than the gap Wr between the first electrodes 124r. Therefore, the transverse electric field Ht is greater than the transverse electric field Hr. As such, according to Formula (1), the liquid crystal layer 106 may have different electric field magnitudes in the reflective region R and in the transmissive region T by individually designing the gap between the first electrodes 124r and the second electrodes 124t, thus generating different birefringence. For example, when an electric field is applied to display bright state, the light may have a phase retardation of half of wavelength after passing through the liquid crystal layer 106 of the transmissive region T, and have a phase retardation of a quarter of wavelength after passing through the liquid crystal layer 106 of the reflective region R, so as to optimize electro-optic properties.

### The Sixth Embodiment

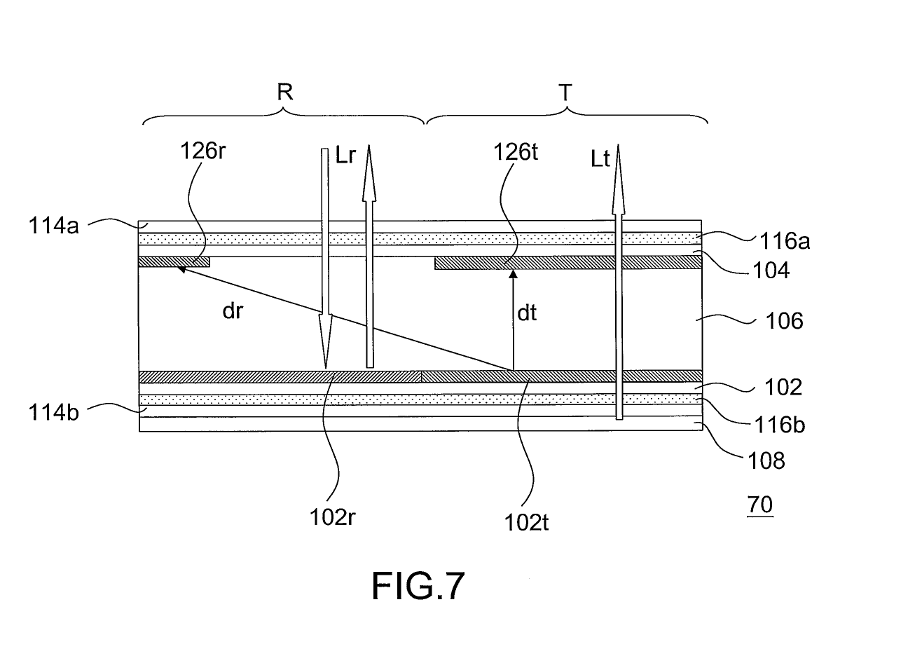

FIG. 7 is a sectional view of a transflective display unit according to a sixth embodiment of the present invention, wherein the elements illustrated in FIG. 2 are represented by the same symbols and the repetitive content of illustration is omitted.

Referring to FIG. 7, the transflective display unit 70 of the present invention includes at least one common electrode 126t and at least one auxiliary electrode 126r. The common electrode 126t is disposed between the opposite pixel unit 104 and the liquid crystal layer 106 in the transmissive region T. The auxiliary electrode 126r is disposed between the opposite pixel unit 104 and the liquid crystal layer 106 in the reflective region R. Electric fields may be generated between the common electrode 126t, the auxiliary electrode 126r, the transparent electrode 102t and the reflective electrode 102r, and the direction of combined electric field is the superposition of electric field dr and dt. In brief, the electric fields in the directions of dr and dt respectively act on the liquid crystal layer 106 in the reflective region R and the transmissive region T. Therefore, according to Formula (1), the liquid crystal molecules of the liquid crystal layer 106 is driven by different electric field magnitudes in the transmissive region T and the reflective region R. Thus, by individually designing the common electrode 126t and the auxiliary electrode 126r, the liquid crystal layer 106 may have different electric field magnitudes in the reflective region R and the transmissive region T, thus generate different birefringence. For example, when an electric field is applied to display bright state, the light may have a phase retardation of half of wavelength after passing through the second liquid crystal layer 106t of the transmissive region T, and have a phase retardation of a quarter of wavelength after passing through the first liquid crystal layer 106r of the reflective region R, so as to optimize electro-optic properties.

In the above embodiments, when no electric field is applied to the liquid crystal layer 106, the liquid crystal layer 106 is optical isotropy, and when an electric field is applied to the liquid crystal layer 106, the liquid crystal layer 106 is optical anisotropy. The transflective liquid crystal display device of the present invention can display an ideal dark state when polarizers are arranged orthogonal to each other, and achieve a high contrast ratio without disposing alignment layers. However, to further enhance the display quality of the transflective display unit, the addition of alignment films can be taken into consideration.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A transflective display unit, comprising:
a pixel unit;
an opposite pixel unit; and
a liquid crystal layer, disposed between the pixel unit and the opposite pixel unit, wherein the refractive index of the liquid crystal layer is changed when an electric field is applied between the pixel unit and the opposite pixel unit, and the birefringence of the liquid crystal layer is proportional to a square of the electric field,
wherein the pixel unit has a reflective electrode such that a reflective region is defined, and a region not covered by the reflective electrode in the pixel unit is covered by a transparent electrode such that a transmissive region is defined.

2. The transflective display unit as claimed in claim 1, wherein a Kerr constant of a liquid crystal material of the liquid crystal layer is between 10⁻⁸ m/V² and 10⁻⁵ m/V^{2.}

3. The transflective display unit as claimed in claim 1, wherein a thickness of the liquid crystal layer in the reflective region is less than that of the liquid crystal layer in the transmissive region.

4. The transflective display unit as claimed in claim 3, further comprising a passivation layer disposed in the reflective region and between the pixel unit and the liquid crystal layer.

5. The transflective display unit as claimed in claim 3, further comprising:
a first polarizer;
a first phase retardation film, disposed outside the opposite pixel unit;
a second polarizer; and
a second phase retardation film, disposed outside the pixel unit, wherein the first polarizer is disposed outside the first phase retardation film, and the second polarizer is disposed outside the second phase retardation film.

6. The transflective display unit as claimed in claim 5, the phase retardation of the first phase retardation film and the second phase retardation film is λ/4 when the wavelength of a light is λ.

7. The transflective display unit as claimed in claim 1, further comprising an isolating wall disposed between the pixel unit and the opposite pixel unit, wherein the liquid crystal layer comprises a first liquid crystal layer located in the reflective region and a second liquid crystal layer located in the transmissive region, and the first liquid crystal layer and the second liquid crystal layer are isolated by the isolating wall.

8. The transflective display unit as claimed in claim 7, wherein a Kerr constant of the first liquid crystal layer is half of that of the second liquid crystal layer.

9. The transflective display unit as claimed in claim 7, further comprising:
a first polarizer;
a first phase retardation film, disposed outside the opposite pixel unit;
a second polarizer; and
a second phase retardation film, disposed outside the pixel unit, wherein the first polarizer is disposed outside the first phase retardation film, and the second polarizer is disposed outside the second phase retardation film.

10. The transflective display unit as claimed in claim 9, the phase retardation of the first phase retardation film and the second phase retardation film is λ/4 when the wavelength of a light is λ.

11. The transflective display unit as claimed in claim 1, wherein the pixel unit further comprises:
a first active device, electrically connected to the reflective electrode to drive the liquid crystal layer located in the reflective region; and
a second active device, electrically connected to the transparent electrode to drive the liquid crystal layer located in the transmissive region.

12. The transflective display unit as claimed in claim 11, further comprising:
a first polarizer;
a first phase retardation film, disposed outside the opposite pixel unit;
a second polarizer; and
a second phase retardation film, disposed outside the pixel unit, wherein the first polarizer is disposed outside the first phase retardation film, and the second polarizer is disposed outside the second phase retardation film.

13. The transflective display unit as claimed in claim 12, the phase retardation of the first phase retardation film and the second phase retardation film is λ/4 when the wavelength of a light is λ.

14. The transflective display unit as claimed in claim 1, further comprising:
a first polarizer, disposed outside the opposite pixel unit;
a second polarizer;
a second phase retardation film, disposed outside the pixel unit, wherein the second polarizer is disposed outside the second phase retardation film;
a third phase retardation film, disposed between the opposite pixel unit and the liquid crystal layer in the reflective region; and
a fourth phase retardation film, disposed between the opposite pixel unit and the liquid crystal layer in the transmissive region, wherein the third phase retardation film and the fourth phase retardation film have different phase retardations.

15. The transflective display unit as claimed in claim 1, wherein the pixel unit further comprises:
a plurality of first electrodes, disposed on the reflective region of the pixel unit; and
a plurality of second electrodes, disposed on the transmissive region of the pixel unit, wherein a gap between the second electrodes is less than that of the first electrodes.

16. The transflective display unit as claimed in claim 15, further comprising:
a first polarizer;
a first phase retardation film, disposed outside the opposite pixel unit;
a second polarizer; and
a second phase retardation film, disposed outside the pixel unit, wherein the first polarizer is disposed outside the first phase retardation film, and the second polarizer is disposed outside the second phase retardation film.

17. The transflective display unit as claimed in claim 16, the phase retardation of the first phase retardation film and the second phase retardation film is λ/4 when the wavelength of a light is λ.

18. The transflective display unit as claimed in claim 1, further comprising:
a common electrode, disposed between the opposite pixel unit and the liquid crystal layer in the transmissive region; and
an auxiliary electrode, disposed between the opposite pixel unit and the liquid crystal layer in the reflective region.

19. The transflective display unit as claimed in claim 18, further comprising:
a first polarizer;
a first phase retardation film, disposed outside the opposite pixel unit;
a second polarizer; and
a second phase retardation film, disposed outside the pixel unit, wherein the first polarizer is disposed outside the first phase retardation film, and the second polarizer is disposed outside the second phase retardation film.

20. The transflective display unit as claimed in claim 19, the phase retardation of the first phase retardation film and the second phase retardation film is λ/4 when the wavelength of a light is λ.
